(19) United States
(12) Patent Application Publication
(10) Pub. No.: US 2014/0123718 A1
(43) Pub. Date: May 8, 2014

(54) LIQUID PHOSPHATE FERTILIZER SOLUTION FOR AGRONOMIC USE

(71) Applicant: José Ramón Florencio Antelo, Rosario - Prov. de Santa Fe (AR)

(72) Inventor: José Ramón Florencio Antelo, Rosario - Prov. de Santa Fe (AR)

(21) Appl. No.: 14/069,711

(22) Filed: Nov. 1, 2013

(30) Foreign Application Priority Data
Nov. 2, 2012 (AR) P12 01 04133

(51) Int. Cl. C05B 17/00

(52) U.S. Cl. CPC C05B 17/00
USPC 71/40

(57) ABSTRACT

A fertilizer is obtained from defluorinated phosphate rock, previously treated in an acidic medium, with the particularity of being almost entirely available and assimilable, ensuring that phosphorus is kept soluble in the soil substrate so that it can be entirely assimilated by plants. It responds to the following reaction: HₙPO₄Xₘ+SO₄⁻²→HₙPO₄^{-m}+SO₄⁻²+NH⁴+H₂O, which at a density of from 1.25 to 1.30, and pH 1.8-2.6, becomes almost entirely available to and assimilable by plants, and remains soluble in the soil stratum. The process developed for yielding the liquid phosphate fertilizer solution is disclosed.

### FIELD OF THE INVENTION

The present invention claimed herein is directed to a LIQUID PHOSPHATE FERTILIZER SOLUTION FOR AGRONOMIC USE; more particularly, a solution that supplies phosphorus in such a way it can be almost entirely assimilated by the plant from the soil substrate.

More specifically, the present invention provides a fertilizer solution obtained from defluorinated phosphate rock, previously treated in an acidic medium, with the particularity of being almost entirely available and assimilable; when losing its liquid state, it can return to that that state after any rainfall while remaining as a salt in the soil, thus ensuring that the phosphorus is kept soluble in the soil substrate so that it can be entirely assimilated by the plant.

Furthermore, the present invention also refers to the industrial process specifically developed for obtaining said liquid phosphate fertilizer, which results from defluorinated phosphate rock that is previously treated in a medium both acidic and corrosive to phosphorus extraction, the reaction of which mostly depends on the nature of the pre-treated rock as follows:

HₙPO₄Xₘ+SO₄⁻²→HₙPO₄^{-m}+SO₄⁻²+NH⁴+H₂O

wherein, at a density of from 1.25 to 1.30, and pH 1.8 to 2.6, turns out to be almost entirely available to and assimilable by plants.

In case that the pre-treated rock does not contain any nitrogen, it is expected that this should be incorporated into the fertilizer during the manufacture process, by means of a hydroxylation device. This formulation, and subsequent treatment, yields a phosphorus, sulfur and nitrogen complex, with poor reactivity values of residual acidity.

The invention defines a novel combination of media intended to achieve a better result, said invention being unpredictable and surprising even to the skilled artisan. As a consequence, apart from being novel, the constructive and functional conception thereof shows a clear inventive step, duly complying with legal requirements to be considered as a patent of invention.

### PRIOR ART

Chemical analyses have shown the existence of at least thirteen elements in all vegetables. The development of agriculture over time, basically the genetic transformation of all seeds as well as the need to address climate changes have dramatically increased the need to use fertilizers to deal with certain issues ranging from world hunger to biofuel provision, thus forcing a significant increase in harvest yields.

As it is very well known, the elements involved in vegetable fertilization are found in the soil at proportions that must be optimized by human action.

In this sense, the liquid fertilizer of the present invention substantially improves phosphorus quality for agronomic use, said fertilizer being completely solubilized, i.e., in the form that the plants absorb nutrients. This solubility significantly decreases the beta threshold in the formation of chemical compounds. In the soil, it is neutral, neither acidic nor alkaline. This feature reduces the phytotoxicity thereof and provides 12 to 15% more plants grown per hectare.

Phosphorus—Function in Plants

Phosphorus is essential for plant growth, where plants absorb most part of phosphorus as primary orthophosphate ion (H2PO4—) and small amounts of phosphorus as secondary orthophosphate ion (HPO4═).

Soil pH impacts directly on the ratio of these two forms, and indirectly, to a great extent, on the absorption of these two forms of P by the plant. P plays an important role in photosynthesis, respiration, energy storage and transfer, cell growth and division, and other processes in plants. Besides, it promotes rapid root formation and growth.

The highest P concentrations in young plants are found on the tissue of growing points. P improves fruit and grain quality, which is critical for seed formation.

The first sign of phosphorus deficiency is a small plant. The shape of the leaves is distorted and, when deficiency is severe, dead spots are developed on leaves, fruits and stems. The most mature leaves are affected before the younger ones. A purple or reddish color, associated with sugar accumulation, appears frequently in young gramineous plants and in other phosphorus-deficient crops, especially at low temperatures.

Phosphorus deficiency delays maturity of the crop. Gramineous plants grown in deficient soils result in a number of tillers or secondary stems much smaller than those planted in more enriched soils.

Reaction in Soil

Phosphorus is very chemically reactive and, for this reason, it is not present in pure state in nature. It is only found in chemical combinations with other elements. Soil phosphorus comes mostly from meteorization of apatite, a mineral containing both phosphorus and calcium. As apatite breaks down and releases phosphorus, several compounds are formed in the soil, orthophosphate ions being released and absorbed by plants. These orthophosphate ions are present in small amounts in the soil solution.

Soil-soluble phosphorus yields compounds with calcium, iron, aluminum and manganese, or it binds to the reactive surface of certain clay minerals, such as kaolinite, aluminum and iron oxides in tropical red soils and allophanic soils, as well as in aluminum-humus complexes in soils derived from volcanic ashes. These reactions reduce phosphorus availability to plants.

Phosphorus from fertilizers, resulting from acids, react with soil minerals forming crystallization products that are less soluble, said reactions being progressive over time.

Phosphorus scarcely moves in most soils. It generally remains in the site it is applied for fertilization. A very small amount of phosphorus is lost due to lixiviation. Erosion and removal in crops are the only two significant ways of phosphorus loss from the soil.

Up to the present time, the amount of phosphorus comprised by a fertilizer has been expressed as phosphorus pentoxide (P₂O₅). This is based on international conventions even when there is no fertilizer in the world with (P₂O₅) and it does not exist as an element in nature. (P₂O₅) is only found at a certain point during conversion of phosphate rock into phosphoric acid, and no matter whether it exists or not, it offers nothing significant from the agronomic perspective.

All solid phosphate products result from phosphoric acid as raw material, while keeping in part their acidity, so to a certain extent they are phytotoxic to seeds (triple superphosphate is alkaline in soil, though showing phytotoxicity, yet to a lesser degree).

These fertilizers possess different amounts of “assimilable” elemental phosphorus (in accordance with the definition provided by fertilizer manufacturers). This amount of elemental phosphorus, which is known as an “assimilable” amount, often confused with availability, is divided by 4.365 for conversion into P2O5 for mathematical purposes, because we are not aware of any other value or rate.

In order to be used as an agricultural fertilizer, solid phosphorus must be stabilized before being employed as a nutrient for plants.

Invariably, out of 100% elemental phosphorus provided, only 30% is solubilized in water under specific soil buffered conditions. To simulate these conditions at the laboratory, a 1-2% citric acid solution is used. During the first year, dilution may be only 10% while reaching at most 30% during the first four or five subsequent years. The remaining elemental phosphorus, up to 70% of the provided phosphorus, is no longer solubilized and becomes part of the total soil phosphorus.

For many years, it was believed that the release of this phosphorus would continue through cation interchange over the years. This is not true, as shown by the professionals disserting during the latest Congress of Soil held in Mar del Plata, Argentina 2012.

Available phosphorus (30%) becomes part of phosphorus measured by traditional methods such as “Bray Kurtz,” “Olsen,” “Melich,” etc., the same phosphorus from which plants can nurture during the following 30 years.

Nevertheless, as phosphorus is an element with high negative charge and great reactivity, as time goes by, elemental phosphorus will form complexes with other nutrients comprised by the soil which have a high positive charge, such as zinc, copper, boron, manganese, calcium, or it will be retained by some clays.

These complexes can be labile, chemical, or easily broken. When these complexes are chemical, they become absolutely unavailable for an indefinite period of time and they override availability of both nutrients to plants.

That is to say, phosphorus availability in a field is decreased with the passing of time (if not added) regardless the amount that can be exported by harvest or used by the plant.

Phosphate Fertilizers

Phosphate rock is the main material used in the production of all phosphate fertilizers. They are classified according to their manufacture process into acid-treated fertilizers or thermally processed materials.

Sulfuric acid (H₂SO₄) and phosphoric acid (H₃PO₄) are used to produce phosphate fertilizers. It is important to point out that, after many years, the common term to define the phosphorus content of a material is “pentoxide”, which does not exist in free form in nature. That is the reason why most commercial products include percentages both as pentoxide (P₂O₅) and elemental form (P) which is known as “assimilable”. The main commercial sources of phosphorus are mono- and di-ammonium phosphates, and superphosphates.

All these products are acidic in soil, except for triple superphosphate that is alkaline, though having phytotoxicity. Phytotoxicity of liquids is higher, and it ends with soil biodiversity, thus limiting biotechnology progress.

The following are some currently well-known phosphate products intended for agronomic use:
Single superphosphate: manufactured using phosphate rock with Sulfuric acid at a concentration ranging from 60 to 72%.
Triple superphosphate: resulting from the reaction between phosphate rock and phosphoric acid.
Ammonium orthophosphates: produced by ammoniation (neutralization with ammonia) of phosphoric acid. Monoammonium Phosphate (MAP) and Diammonium Phosphate (DAP) are produced by controlling the amount of ammonia reacting with phosphoric acid.
Ammonium polyphosphates: Liquid sources of phosphorus produced by ammoniation of superphosphoric acid, thus achieving polyphosphate contents of from 40% to 70%.
Nitric phosphates: manufactured by acidulation of phosphate rock with nitric acid. For the material to be more soluble in water, some Sulfuric acid or phosphoric acid together with nitric acid is employed.

Further Phosphate Fertilizers.
Basic slags. A by-product in the steel industry, widely used as fertilizer in Europe and South America, and to a lesser extent in Asia and North America. This material, also known as “Thomas” slag, has a P₂O₅ content ranging from 7% to 15%. This product was formerly obtained in Argentina but this is no longer the case, due to modernization in the steel industry.
Dicalcium phosphate. This product results from neutralization of phosphoric acid and calcitic lime, providing a scarcely water-soluble phosphate Ca (H₂PO₄)₂. It is essentially used in animal feed, once fluorine and other metal compounds have been removed.
Potassium phosphates. Both these products and the processes of manufacturing thereof have been studied for a long period of time; however, their commercial-scale production shows economical and technological restrictions. Some studies involve reactions between H₃PO₄ and KCl, as well as heating the mixture to produce potassium metaphosphate with a degree of 0-23-30 (0-5437). The most problematic issues are corrosion produced by HCl and few market perspectives for by-products (HCl).
“Renhania” phosphate. Apatite, silica sand and sodium carbonate, mixed in equal ratios and calcined in a furnace at a maximum temperature of about 120° C. The mixture is then cooled down, finely milled, and then granules are formed by adding a mixture of water and starch. The granules are dried, and B and Mg are added. It contains 12% to 13% P (2830% P₂O₅).
Ammonium phosphite. Ammonium phosphite is a product obtained through neutralization of phosphorous acid with ammonium hydroxide solution, consisting mainly of diammonium phosphite [(NH₄)2PO₃] in a stable aqueous solution. The phosphorus atom has a 3-oxidation state. It does not contain a significant amount of available phosphate.
Copper phosphite. Phosphites are phosphorous acid salts that cannot serve as fertilizers, but for their adjoining cation (usually, copper or zinc), since the resulting anion is neither absorbed by plants nor used in their metabolism.
Nitrophosphates. Product obtained by acidulation of phosphate rock with nitric acid. The complex mixture of nitrates and phosphates so obtained does not contain any nitrogen and phosphorus in the same molecule. The process is subjected to modifications intended to remove the obtained hygroscopic calcium nitrate. These modifications include: ammonification, physical separation, co-acidulation with Sulfuric acid and phosphoric acid or, consequently, treatment with carbon dioxide. Generally, it contains dicalcium phosphate, ammonium nitrate, and monoammonium phosphate, although other components may be present. Water solubility of the content of phosphorus varies in a wide range. Products manufactured in USA contain up to 80% or more phosphorus in hydrosoluble forms. It contains about 33% P₂O₅.
Partially acidulated phosphate rock. Finely ground phosphate rock is granulated together with a concentrated urea solution, partially acidulated with Sulfuric acid. This product provides part of the phosphate in a rapidly soluble form so as to ensure rapid growth in plants. It is manufactured and sold in great amounts in Germany, Finland and Brazil. It contains about 40% P₂O₅.
Magnesium thermophosphate. Also called magnesium thermal phosphate. It is a mixture of phosphate rock and magnesium silicate fused in a blast furnace. The mixture is then cooled with water, and used in finely milled form as a fertilizer. It contains between 20% and 24% P₂O₅, and 15%/16% MgO. More than 90% of the product is soluble in citric acid, yet not in neutral ammonium citrate.

### BRIEF DESCRIPTION OF DRAWINGS

FIG. 1 is a flow diagram of the equipment in one embodiment.

### DESCRIPTION OF THE INVENTION

### Advantages

The liquid phosphate fertilizer solution provided by the present invention stands out due to the fact that phosphorus is found in total solution, in the form that plants absorb it as a nutrient, from the very moment it is applied to the soil, and it maintains this state in the solution.

As previously discussed, when analyzing prior art, in well-known fertilizers, elemental phosphorus is soluble up to 30% in water, and under soil buffered conditions.

The solution of the present invention, and the phosphorus obtained thereby, will remain available to plants for the next 30 years, according to the current methods of analysis of phosphorus available in soils, Bray, Bray Kurtz, Melich, Olsen, etc., which do not involve phosphorus immediate availability by plants.

The fertilizer solution of the invention is neutral in soils, neither acidic nor alkaline, so it does not imply any phytotoxicity whatsoever to either seeds or plants, and it can be applied in planting rows together with seeds (none of the current phosphate products can achieve this in the required amounts), leading to 12-15% more plants grown per hectare with the best phosphate product known so far (which must be applied at least 10 cm far from the seeds, either laterally or underneath).

When applied to the rows, maximum doses according to the manufacturer's recommendations should not be exceeded per each soil type, thus avoiding phytotoxicity that results from the inherent salinity of any nutrient. The dose ranges from a maximum of 50 Kg in sand soils to 130 Kg in clay soils.

One of the main concerns with current phosphate fertilizers is that highly reactive phosphorus, having a high negative charge, shows a low beta threshold in the formation of chemical complexes with the positive nutrients comprised by the soil and the components of some clays.

In the fertilizer of the invention the beta threshold has been raised, while achieving—rather than avoiding—a decreased formation of chemical complexes.

In summary, we can establish the advantages of the fertilizer of the invention as follows:

Agronomic Advantages
Given full availability thereof, the amount of phosphorus added to the soil can be accurately determined, which is not possible with solid fertilizers.
High residuality.
Phosphorus does not precipitate because it is in solution form.
Completely compatible with nitrogen fertilizers.
Increased operative capacity of application and plantation equipment.
Lower costs.
Fertilization with high ambient humidity.
Compatibility with agrochemicals.
Safe handling.
The agronomic result is observed in all soils it has been tested, and in all crops responding to phosphorus.

Application Advantages
Wide application range.
Accurate dosage, uniform application.
Increased operative capacity of application and plantation equipment.
Multiple application possibilities.
Reduced application and operation costs.

Logistic Advantages
Easy handling;
Easy maintenance;
Easy distribution.
No alteration under storage, no volatilization or lixiviation when applied to soils.

Manufacture Process

As per the process for producing the fertilizer of the invention as described above, it is possible to state that it is developed in line with the following operative stages:
1. A water volume (usually 5,000 liters) is placed in the reactor;
2. Sulfuric acid is added at a ratio ranging from 20% to 30% (depending both on Sulfuric acid quality and pre-treated rock).
3. Pre-treated rock is added (preferably MAP 3250 Kg.). The quality of the raw material is essential.
4. Once treatment has begun, air compressors are started and the recirculation pumps are operated for a period of from 1¼ h to 2 h, at a temperature of from 30° C. to 40° C., resulting from reaction of the acid with water.
5. Centrifugation processes are then carried out (for example, by decanting) to yield a liquid and crystalline product.
6. A coloring, complexing and stabilizing agent is added. To this end, methylthionine chloride and sodium salicylate is employed.
7. Once room temperature is reached, the desired color is provided.
8. Then it is brought to a density of from 1.25 to 1.30, pH 1.8-2.6, yielding a liquid fertilizer with the particularity of being 100% available and assimilable, besides remaining in this state.

Under the above conditions, the whole phosphorus becomes soluble in the soil substrate, and can be assimilated by plants

### Example

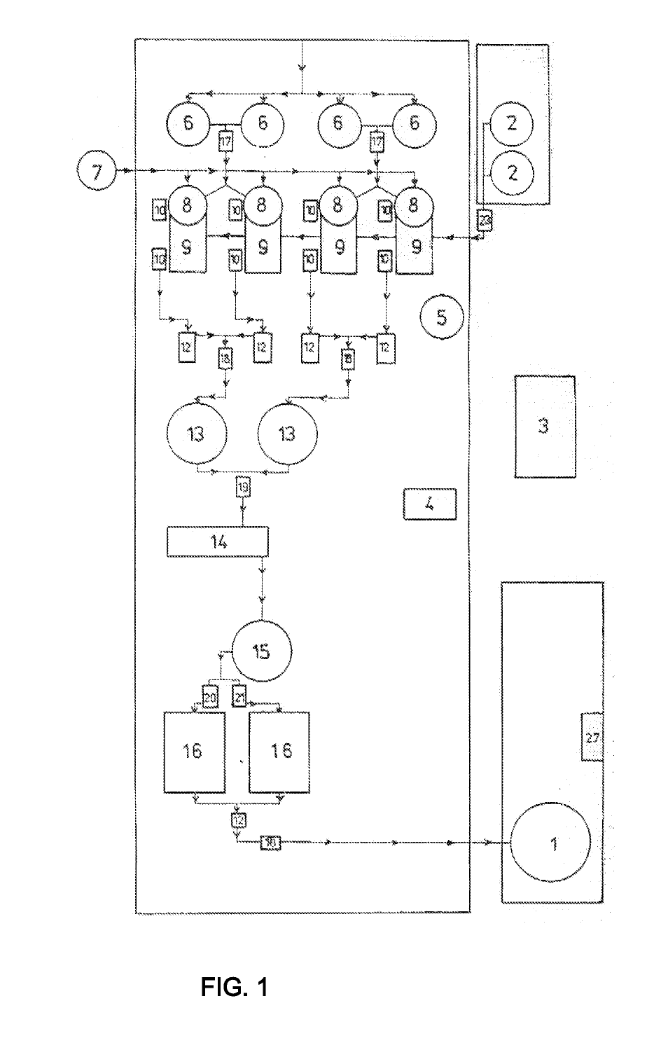

With a view to obtaining the advantages mentioned above, to which users and skilled artisans may add a number of additional advantages, and for the sake of clarity of the constitutive and functional features of the liquid fertilizer of the present invention, an example of the process for producing the fertilizer (to which end a scheme is attached) is described in FIG. 1, wherein the recourses and elements used are represented. However, it should be explicitly specified that this example is not be interpreted as being exclusive or restrictive of the scope of the present patent application, but it is merely explanatory and illustrative of the basic conception on which this invention is based.

In the scheme identified as FIG. 1, the following equipment, devices and elements are illustrated;
1. Final storage tanks, having a capacity of 128 m³, with reinforced concrete retaining walls (40 m×16 m×4 m);
2. Sulfuric acid tanks, having a capacity of 23,000 L
3. Solid container (12 ton hopper);
4. Compressors, stirrers;
5. Auxiliary tank (10,000 L);
6. Decanters (8,000 L) (for water supply);
7. MAP feeding engine (5.5 Hp);
8. Phosphorus-receiving sheet metal hoppers, for reactor load;
9. PVC tanks, reactors having a capacity of 10,000 L each. A respective Sulfuric acid feeding tank is placed on each reactor (600 L each);
10. Mixing pumps in reactors. They are made of stainless steel 316, flow-rate 30,000 l/h, 5.5 HP;
11. Filters made of bent sheet metal, 3 mm, having 1 mm diameter holes, with a manhole support member, made of the same material, covered with wadding, for lining 2500 liter PVC tanks;
12. PVC intermediate tanks, having a capacity of 23,000 liters each;

13. “Westfalia” decanter;
14. PVC intermediate tank with a capacity of 23,000 liters;
15. Centrifuges;
16. Water supply pumps (flow-rate 30,000 l/h and 15 Hp);
17. Pumps (30,000 l/h, 10 Hp);
18. Screw pump (8,000 l/h, ½ Hp);
19. Pump (4,000 l/h and ½ Hp);
20. Pump (6,000 l/h and 1.5 Hp);
21. Filter (see 13 above), polar fleece instead of wadding;
22. Pump (5,000 l/h and 1.5 Hp);
23. Rapid loader for 30,000 l/h with 10 Hp engine;

In order to obtain the liquid phosphate fertilizer of this invention, the following stages are successively conducted:
a) Five tons of tap water supplied from decanters (6) are placed into reactors (9).
b) An amount of from 20% to 30% Sulfuric acid from tanks (2) is added.
c) Rock is added, supplied with engines (7) and transported with trucks to hoppers (8) whereby it is distributed to reactors (9).
d) The added material is maintained in motion for1¼ h to 2 h, using centrifugal pumps (10) and air from compressors (4).
e) The resulting product is transmitted to intermediate tanks (13), allowing for cleaning of the reactors. The tanks are fitted with an air system for maintaining uniformity of the product conducted to the decanter and the centrifuge, and in such a way H₄ of the acids is completely neutralized.
f) The product previously passes through filters (12) to remove soldering iron residues from phosphorus.
g) When leaving the filters, the resulting product is derived to a horizontal decanter (14), wherein 90% solid residues are removed from the product.
h) The product goes through another intermediate tank (15).
i) The product is transported by a set of centrifuges (16) to remove all turbidity therefrom, thus becoming a crystalline product.
j) After the above process, the obtained product goes to the final reservoirs (1).
k) Solid residues from decanter (14) and centrifuges (16) are collected in a reservoir (3) to be used as out-of-specification fertilizers, thus obtaining liquid sulfur-nitrogen phosphate.

Having described and exemplified the nature and main object of the present invention, as well as the way it is carried out in practice, the following is claimed as proprietary and exclusive right:

1. A LIQUID PHOSPHATE FERTILIZER SOLUTION FOR AGRONOMIC USE, obtained from defluorinated phosphate rock, previously treated in an acidic medium, with the particularity of being almost entirely available and assimilable, apart from being maintained in solid state, ensuring that phosphorus is kept soluble in the soil substrate so that it can be entirely assimilated by the plant, characterized in that it responds to the following reaction:
HₙPO₄Xₘ+SO₄⁻²→HₙPO₄^{-m}+SO₄⁻²+NH⁴+H₂O
wherein, at a density of from 1.25 to 1.30, an pH 1.8 to 2.6, becomes almost entirely available to and assimilable by plants.

2. A LIQUID PHOSPHATE FERTILIZER SOLUTION FOR AGRONOMIC USE, according to claim 1, characterized in that the phosphorus content remains soluble in the soil substrate.

3. A LIQUID PHOSPHATE FERTILIZER SOLUTION FOR AGRONOMIC USE, according to claim 1, characterized in that it has a crystalline appearance, methylthionine chloride and sodium salicylate being used as coloring, complexing and stabilizing agents, while maintaining a density of from 1.25 to 1.30, and pH ranging from 1.8 to 2.6.

4. AN INDUSTRIAL PROCESS for obtaining the liquid phosphate fertilizer solution according to any one of the preceding claims, characterized in that after placing said fertilizer solution in the reactor, five tons of tap water, containing 20%-30% Sulfuric acid and 3250 Kg monoammonium phosphate are added, wherein the mixture is maintained in motion through centrifugal pumps, for a period of 1¼ hours to 2 hours.

5. AN INDUSTRIAL PROCESS, according to claim 4, characterized in that the product obtained by the process is taken to intermediate tanks fitted with an air system to maintain uniformity of the product conducted to the decanter and the centrifuge, so as to complete neutralization of H₄ from the acids (to allow cleaning of the reactors), after going through the filters used to remove soldering iron residues from phosphorus.

6. AN INDUSTRIAL PROCESS, according to claim 4, characterized in that the product obtained by the process is filtered and then conducted to a horizontal decanter to remove 90% solid residues, and then it is conducted to another intermediate tank, prior to passing through a set of centrifuges to remove all solids from the product, which then becomes crystalline.

7. AN INDUSTRIAL PROCESS according to claim 4 for yielding the liquid phosphate fertilizer solution of the previous claims, characterized in that it comprises the following successive operative stages:
1. A predetermined water volume is placed in the rector.
2. Sulfuric acid is added at a ratio of between 20% and 30%.
3. Pre-treated rock is added (preferably MAP 3250 Kg).
4. To begin treatment, compressors and recirculation pumps are operated for a period of from 1¼ hour to 2 hours.
5. H₄ is removed in the intermediate tanks by air stirring while the product is maintained in a homogeneous state for the subsequent centrifugation process.
6. Centrifugation processes are carried out until a liquid and crystalline product is obtained.
7. A coloring, complexing and stabilizing agent is added, such as methylthionine chloride and sodium salicylate.
8. Once room temperature has been reached, the desired color is provided.
9. Then it is brought to a density of from 1.25 to 1.30, and pH ranging from 1.8 to 2.6.
